(19) United States
(12) Patent Application Publication
(10) Pub. No.: US 2007/0109979 A1
(43) Pub. Date: May 17, 2007

(54) Method and conference controller for cluster-based conferencing

(76) Inventors: Chunyan Fu, Montreal (CA); Roch Glitho, Montreal (CA); Rachida Dssouli, Montreal (CA)

Correspondence Address: ALEX NICOLAESCU;Ericsson Canada Inc., Patent Department, 8400 Decarie Blvd., Town Mount Royal, QC, H4P 2N2, CA

(21) Appl. No.: 11/280,206

(22) Filed: Nov. 17, 2005

(51) Int. Cl. H04Q 11/00

(52) U.S. Cl. 370/261

(57) ABSTRACT

A method and conference controller for cluster-based conferencing between ad-hoc network terminals supporting cluster-based conferences and legacy network terminals not equipped with such capabilities. The controller implements a Super User Agent (SUA) having a conference identity, a cluster member list including identities of legacy network's terminals members of a cluster of terminals of the legacy network participating to the conference, and a cluster neighbour list that identifies terminals from an ad-hoc network that act as a super member of a cluster of terminals of the ad-hoc network. Responsive to receipt of a first message for establishing the conference between an ad-hoc network terminal and a legacy network terminal, the SUA sends a second message to establish a connection between the conference controller and one of the legacy network terminal and the ad-hoc network terminal, stores information relative to the conference, and notifies the terminals that the connection for use by the conference is established.

### BACKGROUND OF THE INVENTION

1. Field of the Invention

The present invention relates to cluster-based communications between terminals in different networks.

2. Description of the Related Art

An ad-hoc (or “spontaneous”) networks are typically small networks such as for example wireless networks or temporary plug-in connections, in which at least some of the network devices are part of the network only for the duration of a given communications session or, in the case of mobile devices, while in some close proximity to the rest of the network. In ad-hoc networks, devices can quickly and easily join or leave a communications session using, for example, various types of wired or wireless accesses, such as a cellular-based access, Local Area Network (LAN) access, Wireless LAN (WLAN) access, or Bluetooth technology access.

The applications of ad-hoc networks are vast, and include, for example, allowing people to come to a conference room and using infrared transmission or radio frequency (RF) wireless signals to join their notebook computers with those of other conferees to a local network with shared data and printing resources, or the constitution of ad-hoc teleconferences (audio and/or video) for personal or business use.

Ad-hoc networks comprise heterogeneous nodes that communicate without a pre-existing network infrastructure dedicated to the ad-hoc network. The later rather forms on top of existing architecture of other networks. For example, an ad-hoc network can form when a cellular subscriber of an IP-based cellular network contacts a WLAN user in a WLAN hot-spot and invites him to a tele-conference. A third party from a corporate LAN can further join the conference. This model fits quite well in ad-hoc peer-to-peer networks settings and is the basis of numerous applications including public debates and gaming.

Thus, ad-hoc networks form spontaneously without the need of their own dedicated infrastructure or of a central controller. Such a peer-to-peer system infers that each node, or user, in the network can act as a data endpoint or intermediate repeater.

Terminals' mobility in multiparty sessions that takes place in peer-to-peer ad-hoc networks engenders a critical issue related to signaling.

Peer-to-Peer (P2P) is a paradigm of structure distributed applications, in such a way that individual nodes have symmetric roles. Peer-to-peer networks do not have to be ad-hoc and most existing peer-to-peer networks are actually not. However, ad-hoc networks usually rely on peer-to-peer communications, especially when they are mobile. This is due to the lack of pre-existing and non-transient infrastructure such as centralized servers.

Significant work has been done in the area of signaling for multiparty sessions in traditional networks, such as for example with the development of the Session Initiation Protocol (“SIP: Session Initiation Protocol”, by J. Rosenberg et al., Request for Comments RFC 3261, June 2002.), all of which is herein included by reference), the International Telecommunication Union-Telecommunication (ITU-T) H.323 protocol (H.323 series, ITU-T recommendations, Geneva 2003, which is also herein included by reference in its entirety), and ICEBERG (by Helen J. Wang, et al., and “Iceberg: An Internet Core Network Architecture for Integrated Communications”, IEEE Personal Communications, August 2000, which is also herein included by reference). Work has also been dedicated to the low layers issues of ad-hoc networks (e.g. routing), and also to the non-multiparty session applications in peer-to-peer networks (e.g. Gnutella, Freenet). However, no or little work has been done so far on signaling in peer-to-peer ad-hoc networks.

Signaling in peer-to-peer ad-hoc networks is quite challenging. Participants to such a network may join or leave at any time. The information exchanged by participants also needs to be propagated in a distributed manner since there is no centralized server in the network. Resources also need to be used in an optimal manner due to the peer-to-peer structure so that peers with limited resources can rely on the resources of the other peers. Therefore, signaling constitutes the nerve center of peer-to-peer multi-party sessions carried over ad-hoc networks. Signaling enables the initiation, the modification and the termination of these sessions.

None of the existing signaling systems meets these requirements. For example, H.323 comprises a centralized entity, i.e. the H.323 Multipoint Control Unit (MCU), and has only a medium scalability level. It does not have a dynamic sessions management capability, and lacks an optimal usage of recourses. The full mesh version of SIP (by Mark/Kelley, “Distributed Multipoint Conferences using SIP”, IETF Internet Draft, Mar. 8, 2000, also included by reference herein) does not comprise a centralized entity, but has an even lower scalability level. It also has a low level of dynamic sessions management capability, and lacks an optimal usage of recourses (note: SIP does define centralized servers but it has been discussed as full mesh manner in the reference document above). Finally, Iceberg also comprises a centralized entity. Although it has a high scalability level and a dynamic sessions management capability, it lacks an optimal usage of recourses.

The co-pending, co-owned patent application Ser. Nos. 10/999,955, 10/999,944 and 10/999,920, all of which were filed on Dec. 1, 2004 in the names of Glitho et al., provide a solution to this problem, which is distributive, scalable and optimized for each terminal's processing resources. In these applications (called herein the co-owned applications, which are herein included by reference in their entirety), there is taught a user agent and a super user agent for use in terminals and nodes for cluster-based multi-party conferencing using one or more clusters of terminals and nodes. Each cluster includes a super member comprising a super user agent, and one or more members, each including a user agent.

The user agent comprises an identity of the super member terminal of the cluster, a conference identity identifying the cluster-based conference being carried on, cluster parameters including a split value (Sv) indicative of a maximum number of terminals that may be part of the cluster, wherein when Sv is reached during the conference the cluster is split, and a merge value (Mv) indicative of a minimum number of terminals that may be part of the cluster, wherein when Mv is reached the cluster is merged with another cluster.

The super user agent, which may be elected based on its higher processing resources, comprises a cluster member list with all terminals of the cluster, the conference identity, a cluster neighbour list identifying any other one or more neighbour terminals including a super user agents of super members of other clusters, the one or more terminals also participating to the same conference, and the cluster parameters. One or more cluster of terminals are constituted over an ad-hoc network for carrying a multi-party, cluster-based, conference, wherein each cluster includes a super member comprising its super user agent, and one or more members including a user agent. Communications sessions are established between the super member of each cluster and each member terminals of the same cluster, and between the super members of each one of the clusters.

Methods of signalling are also provided for establishing the multi-party conference and for carrying on the conference, as participants join or leave the conference. First, two or more terminals participating to the conference are joined in a cluster, wherein one of them is elected as a super member of the cluster. The other terminal is updated with the identity of the super member terminal, the identification of the conference, and with cluster parameters including the split value Sv and the merge value Mv. A method for splitting the cluster, and a method for merging two clusters are also provided.

However, the teaching of these co-owned applications is limited to the establishment and handling of multi-party conferences in ad-hoc networks where each participant supports SIP with clustering extensions required for forming a multi-party cluster (for example supports the SIP extensions for exchanging the cluster information, incusing super member identity, cluster parameters, etc). Still, it is not all SIP-based terminals that support clustering extensions of SIP. Instances arise where a SIP-based terminal of a Third Generation (3G) network, for example, does not support these extensions, and therefore cannot correctly interpret incoming SIP messages that carry these extensions, nor can it issue SIP responses with these extensions. As a consequence, such a terminal cannot benefit of the methods for carrying on a cluster-based multi-party conference as described in these co-owned patent applications.

Although there is no prior art solution as the one proposed hereinafter for solving the above-mentioned deficiencies, the U.S. patent application US2002/0042693 by Kampe at al. (hereinafter called Kampe) bears some relation with the field of the present invention. Kampe teaches a system and methods within a high availability network for monitoring and managing cluster membership. A cluster membership monitor provides the ability to maintain a list of current cluster members, monitor status of each node of the cluster, stay apprised of each node's viability, elect a master node for the cluster when necessary, and coordinate cluster reformation as members join and leave the cluster. However, Kampe's system comprises a centralized node, i.e. the cluster membership monitor, and therefore it is not applicable to ad-hoc networks.

The U.S. patent application US 2003/0204509 by Dinker at al. (hereinafter called Dinker) also bears some relation with the field of the present invention. Dinker teaches a distributed system providing for separate management of dynamic cluster membership and of distributed data. Dinker's nodes of the distributed system include a state manager and a topology manager. The state manager handles data access from the cluster, while the topology manager handles changes to the dynamic cluster topology, such as when new nodes join or exit the cluster. However, the teaching of Dinker is limited to a system able to form one cluster at a time.

Accordingly, it should be readily appreciated that in order to overcome the deficiencies and shortcomings of the existing solutions, it would be advantageous to have a method and system that allows SIP-based terminals that do not support clustering to be able to participate to cluster-based multi-party conferences that also involve ad-hoc network participants supporting clustering. The present invention provides such a method and system.

### SUMMARY OF THE INVENTION

It is an object of the present invention to provide a method for multi-party conferencing between terminals of an ad-hoc network and terminals of a legacy network, the method comprising the steps of:

a. receiving at a conference controller of the legacy network a first message for an establishment of a conference between a terminal in the ad-hoc network and a terminal in the legacy network;

b. responsive to a receipt of the first message, sending from the conference controller a second message to establish a first connection between the conference controller and one of the terminal in the legacy network and the terminal in the ad-hoc network;

c. updating a Super User Agent (SUA) of the conference controller with information relative to the conference, the SUA being for use in establishing cluster-based conferences, and comprising:
a conference identity that identifies the conference;
a cluster member list including identities of terminals of the legacy network that are members of a cluster of terminals of the legacy network which participate to the conference; and
a cluster neighbour list that identifies at least one terminal from the ad-hoc network that acts as a super member of a cluster of at least one terminal of the ad-hoc network, the at least one terminal from the ad-hoc network also participating to the same conference; and

d. notifying at least one of the terminal in the ad-hoc network and the terminal in the legacy network that the first connection for use by the conference is established.

It is another object of the present invention to provide a conference controller of a legacy network, comprising:

a super user agent for use in establishing cluster-based conferences, the super user agent comprising:
a conference identity that identifies a given conference;
a cluster member list including identities of any terminals of the legacy network that are members of a cluster of terminals of the legacy network which participate to the given conference; and
a cluster neighbour list that identifies at least one terminal from an ad-hoc network that acts as a super member of a cluster of at least one terminal of the ad-hoc network, the at least one terminal from the ad-hoc network also participating to the given conference;

the super user agent, responsive to a receipt of a first message for an establishment of the given conference between a terminal in the ad-hoc network and a terminal in the legacy network, sending a second message to establish a first connection between the conference controller and one of the terminal in the legacy network and the terminal in the ad-hoc network, storing information relative to the given conference, and notifying at least one of the terminal in the ad-hoc network and the terminal in the legacy network that the first connection for use by the given conference is established.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is an exemplary high-level representation of an ad-hoc network formed to handle a multi-party conference using terminal clusters according to the teaching of the co-owned applications;

FIG. 2 is an exemplary high-level representation of a user agent employed for handling a multi-party conference using terminals clusters according to the preferred embodiment of the present invention;

FIG. 3 is an exemplary high-level representation of a super user agent employed for handling a multi-party conference using terminal clusters according to the preferred embodiment of the present invention;

FIG. 4 is an exemplary high-level nodal operation and signal flow diagram representing a terminal of an ad-hoc network that establishes a connection with a terminal that does not support clustering, according to a first exemplary scenario of the preferred embodiment of the present invention;

FIG. 5 is another exemplary high-level nodal operation and signal flow diagram representing a terminal of an ad-hoc network that establishes a connection with a terminal that does not support clustering, according to a second exemplary scenario of the preferred embodiment of the present invention;

FIG. 6 is yet another exemplary high-level nodal operation and signal flow diagram representing a terminal that does not support clustering, which establishes a connection with a terminal of an ad-hoc network according to a third exemplary scenario of the preferred embodiment of the present invention; and

FIG. 7 is yet another exemplary high-level nodal operation and signal flow diagram representing a terminal that does not support clustering, which establishes a connection with a terminal of an ad-hoc network according to a forth exemplary scenario of the preferred embodiment of the present invention.

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

In peer-to-peer ad-hoc networks there is no centralized signaling entity. Signaling sessions should be maintained dynamically because participants may join or leave at any time. This implies that information is properly propagated to all nodes, although there is no centralized server. Furthermore, the system should be scalable because a multiparty session starting with a couple of participants may grow to thousands of participants depending on the application. The system should be light-weigh because nodes in ad-hoc networks usually have limited processing capabilities, and resources should be used optimally because some nodes may not have enough processing power and have to rely on the processing power of other nodes, as it is done in all peer-to-peer networks.

The co-owned patent application Ser. Nos. 10/999,955, 10/999,944 and 10/999,920, all of which were filed on Dec. 1, 2004 in the names of Glitho et al., provide a certain solution for carrying on cluster-based multi-party conferences in ad-hoc networks. This solution is distributive, scalable and optimized for each terminal processing resources. According to the co-owned applications, a clustering concept is used for setting up ad-hoc networks for multi-party conferencing, because it enables scalability and does not require centralized control. A signalling User Agent (also called herein UA) is a functional entity, which resides in each peer (also called herein terminal). At any given time, it acts as either a cluster member (having a functional user agent) or a super member (having a functional super user agent). At any given time, there is also only one super member in a cluster of members and all the members are connected to it. Super members are also interconnected among each other having direct links with super members of neighbouring clusters that participate to the same conference. According to the teaching of the co-owned applications, in order to carry on a multi-party conference in an ad-hoc network, clusters are dynamically created and deleted. As members join or leave the conference, clusters can split and merge during the given multi-party conference. The key parameters used for carrying out the invention are clustering parameters including a split value (Sv), and a merge value (Mv), which are defined for each cluster of terminals. If the number of terminals in a cluster reaches Sv, such as when new terminals join the conference, the cluster is split in two. If it reaches Mv, such as when terminals leave the conference, the cluster merges with another cluster of the same conference.

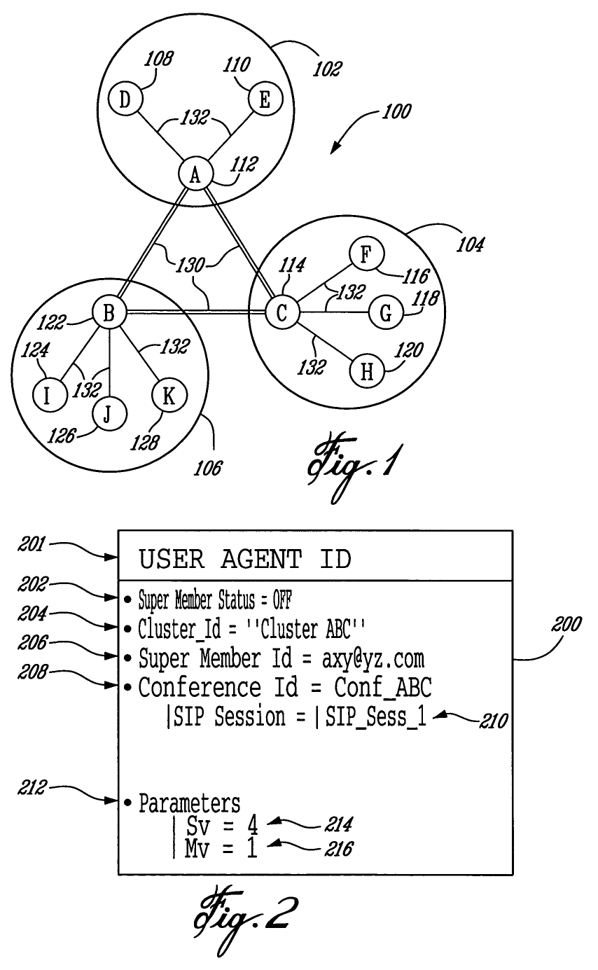

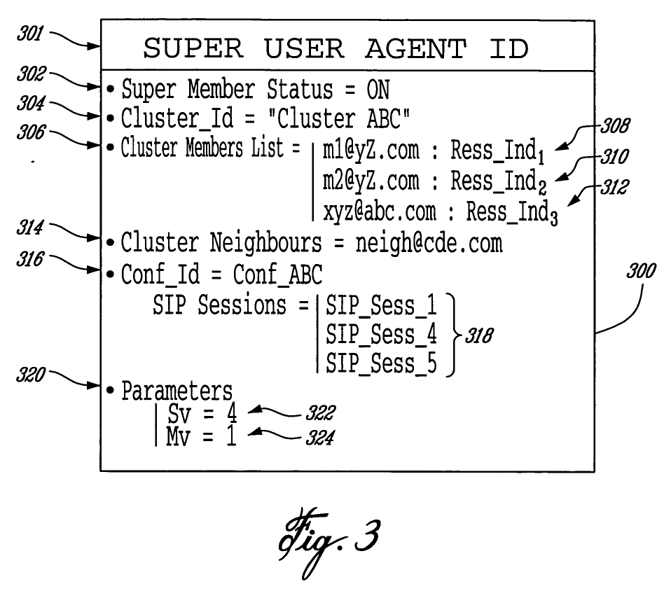

Reference is now made to FIG. 1, which is an exemplary high-level representation of an ad-hoc network 100 formed to handle a multi-party conference using terminals clusters 102, 104, and 106 according to the teaching of the co-owned applications. Each such cluster comprises one or more terminals, which are members or super members of the cluster. Only one super member resides in each cluster. In the present example, terminals A 112, C 114, and B 122 are the super members of the three respective clusters 102, 104, and 106, and therefore have signaling links 130 established therebetween. Each member of the clusters has signaling links 132 established with its direct super member. As mentioned, each member or super member comprises either a user agent or super user agents that implement a signaling protocol capable of establishing cluster-based multi-party conferences, such as for example SIP.

According to the teaching of the co-owned applications, a super member may be elected when a new cluster is created, when an existing super-member leaves the cluster, or when two clusters merge or split. The member who is elected is preferably the member with the most resources (e.g. processing power/memory), although it is contemplated that other considerations may be used as well, such as for example the belonging to a same network operator, etc. Super members keep track of members' resources, or of any other criteria used for the super member election. This allows them to designate a new super member when the later leaves a multi-party conference or when the cluster splits. A super member keeps track as well of the level of resources of the super-member of each cluster involved in the conference. This aids in the selection of a new super-member when two clusters merge with each other. The first cluster is created when the first two participants to the multi-party conference are connected and a super member is then elected. The last cluster is deleted when the last participant leaves the conference.

New members may be added to a cluster. When multiple clusters are present in the same conference, the super member then propagates the information to the other super members. When a member leaves, it terminates its connection with the super member and the super member propagates the information to the other super members. If the member who leaves the conference is a super member, it also designates its replacement before leaving, following the established super member election procedure (e.g. based on the highest resources of a member of the cluster).

When a new member is added to the cluster, the super member of the cluster initiates the split procedure if the size of the cluster reaches Sv, the split value. Typically, the super member remains super member of the existing cluster, and a new super member is elected for the new cluster.

If the size of the cluster reaches the merge value Mv when a member leaves, the super member of the cluster initiates a merge procedure with another cluster. It consists of searching for another cluster of the same conference with which to merge, with the constraint that the size of the new cluster resulting from the merging should be less than Sv, the split value. A super member of the new cluster formed by the merging is elected as soon as the merging is done.

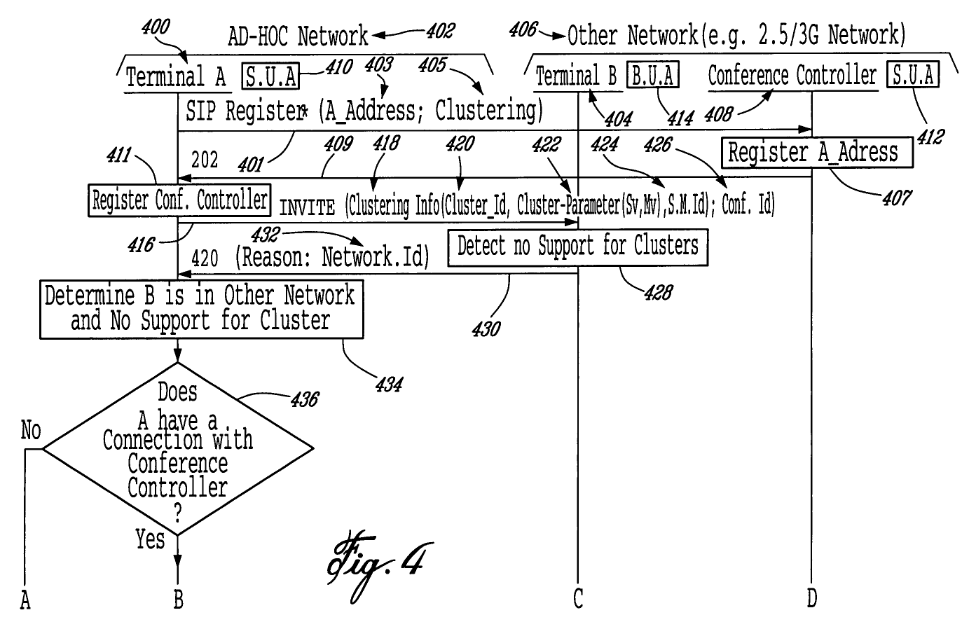

Reference is now made to FIG. 2, which is an exemplary high-level representation of a user agent used for handling a multi-party conference using clusters of terminals according to the preferred embodiment of the invention. Such a user agent 200 may be implemented in a given terminal or another type of communications node using software and/or hardware modules, or any combination thereof. It comprises a user agent identification 201, and an indication 202 of its status, i.e. if it acts either as a member or a super member. The user agent further comprises the identity 204 of the cluster it is part of, and the identity 206 of its corresponding super member, which manages the cluster. In addition, it includes the identity 208 of the multi-party conference to which it participates, which may include the identity 210 of the communication session (also called herein connection) it establishes with the corresponding super member of the cluster. Finally, when the user agent 200 is implemented in a terminal of an ad-hoc network, the user agent 200 comprises cluster's parameters 212 indicating the split value Sv 214 and the merge value Mv 216 of the cluster. Typically, the cluster's parameters 212 remain constant throughout the duration of a given multi-party conference, while other information stored in the user agent may be changed as members join or leave the conference, as it will described hereinafter in further details. When the user agent 200 is rather implemented in a conference controller of a legacy network, the parameters 212 are not needed, and thus can be skipped.

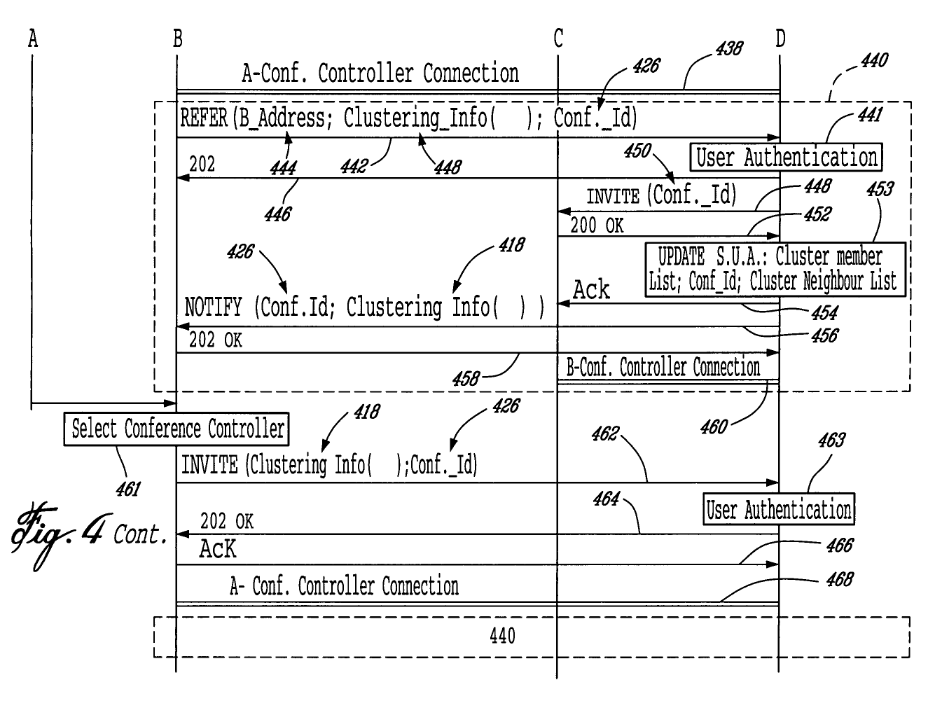

Reference is now made to FIG. 3, which is an exemplary high-level representation of a super user agent employed for handling a multi-party conference using terminals clusters according to the preferred embodiment of the invention. Such a super user agent 300 may be implemented in a given terminal of an ad-hoc network using software and/or hardware modules, or any suitable combination thereof. The super user agent can also be implemented in a conference controller of a legacy network, which scenario is yet to be described.

The super user agent 300 comprises a super user agent identification 301, and an indication 302 of its super member status, i.e. it acts as a super member for the cluster it is part of. The super user agent 300 further comprises an identity 304 of the cluster it manages, and a cluster members' list 306 that comprises identities 308, 310, and 312 of the other members of the cluster, along with an indication of each member's resources (Ress_Indᵢ). Furthermore, the super user agent 300 comprises a cluster's neighbors list 314 that identifies the neighbors of the cluster, i.e. the other super members of other clusters that participate to the same multi-party conference, in case such other super members exist within that same conference. Finally, the agent 300 comprises the identity 316 of the multi-party conference to which it participates, which may include the identities 318 of each individual sessions it establishes with super members of list 314 and with the other members 308-312 of its cluster. The super user agent 300 also includes, typically when implemented in a terminal of an ad-hoc network, cluster parameters 320 indicating the split value Sv 322 and the merge value Mv 324 of the cluster. Typically, the parameters 320 remain constant throughout the extent of a given conference, while the other information may be changed as members join or leave the conference, as it will described hereinafter in further details. When the super user agent 300 is rather implemented in a conference controller of a legacy network, the parameters 320 are not needed, and thus can be skipped.

The co-owned applications propose an advantageous implementation using SIP, although it is recognised that other signalling protocols may be used as well. The IETF's SIP was proposed because SIP is lightweight and extensible. The co-owned applications proposed possible extensions to SIP for their implementation, such as new SIP parameters called “Clustering”, which may be included in the SIP “Supported” header field to indicate that multi-party conferencing using clusters is supported by a sender of a message. The functional SIP entity used for carrying out the signalling scenarios described in the co-owned applications is the user agent (UA) and the super user agent (SUA). UA is the functional entity residing in a cluster's member terminal, while a SUA is the functional entity of a super member terminal. At any given time a UA or SUA is in only one cluster. This cluster has a unique identifier and also a set of parameters, as described with reference to FIGS. 2 and 3. UA and SUA store the cluster identifier, the cluster parameters, but also the super member id. In addition the SUA stores the list of cluster members and neighbouring clusters. A conference is also uniquely identified and is made of a set of connections among participants and clusters as described hereinabove.

However, the teaching of the co-owned US patent applications is limited to the establishment and handling of multi-party conferences in ad-hoc networks where each participant supports the Session Initiation protocol (SIP) with clustering extensions required for forming a multi-party cluster. It is because of the support of cluster-based multi-party conferences, that the participants described in the co-owned application can set-up, control, and tear down sessions while participating to a cluster-based conference.

Still, it is not all SIP-based terminals that support the proposed clustering extensions of SIP. Instances arise where a SIP-based terminal of a Third Generation (3G) network, for example, does not support the required clustering extensions, and therefore cannot correctly interpret incoming SIP messages that carry these extensions, nor can they issue SIP responses with these extensions. As a consequence, such terminals cannot benefit of the methods for carrying on a cluster-based multi-party conference as described in the co-owned patent applications.

The present invention proposes a method and system for carrying on cluster based multiparty conferences that involve participants from ad-hoc networks as well as participants from other networks with terminals that do not support the clustering extensions required for handling a cluster-based multiparty conference. For example, the present invention allows a 3G network subscriber having a SIP-based 3G terminal that does not support the clustering extensions described in the co-owned applications, to be able to still participate in ad-hoc multiparty conferences. In the present invention a compromise is made regarding the distribution of the multiparty conference in order to accommodate the participation of terminals that do not support the clustering extensions. According to the present invention, in legacy networks where (at least certain) terminals do not implement such extensions, such as for example in a legacy 3G network, conferences are being handled following a centralized model where signaling is still based on SIP, but wherein a centralized controller called the conference controller is responsible for setting up, controlling and tearing down multiparty conferences on behalf of the conference participants from the legacy network. The conference controller may be implemented in a Media Resource Function Controller (MRFC), which is the functional entity that handles signaling or in an Application Server (AS), which hosts the conferencing application in the 3G network. According to the present invention, in such a legacy network, the conference controller supports the clustering extensions described herein before with reference to the co-owned applications on behalf participant terminals that do not have such capabilities. Upgrading the conference controller in a 3G network for example, in order to allow 3G subscribers to be able to participate to cluster-based multiparty conferencing can be easily performed, thus avoiding the upgrade of all the legacy networks terminals, which besides being much more expensive. The conference controller upgrade for the support of clustering extensions is straightforward also because it already supports the core signaling system of SIP.

According to the present invention, the conference controller is configured so that it is perceived by ad-hoc networks terminals as a special super member of a cluster. For this purpose, the conference controller comprises a SUA as previously described. However, contrary to the previous description of a super member, the conference controller is so configured, during a given conference, as to never leave the conference or its cluster by merging with another cluster, by splitting from a given cluster, or simply by quitting the conference. Thus, the SUA of the conference controller may not comprise the Sv and the Mv, since it does not use them for splitting or merging. From the perspective of the legacy network terminals (terminals from the same network as a conference controller), the conference controller is perceived as a centralized control point to which all other parties, including the parties in the ad-hoc networks, are connected, so that the conference controller represents a bridge between conference participants from the legacy network and participants from the ad-hoc network. The controller can generate and process both SIP core signaling messages and SIP messages with clustering extensions.

Reference is now made to FIG. 4, which is an exemplary high-level nodal operation and signal flow diagram representing a terminal A 400 of an ad-hoc network 402 that establishes a connection with a terminal B 404 that does not support SIP clustering extensions, according to a first exemplary scenario of the preferred embodiment of the present invention. The terminal B 404 is part of a legacy network 406, such as for example part of a 2.5G telecommunications network like the General Packet Radio Service (GPRS) or of a 3G telecommunications network like the Universal Mobile Telephone System (UMTS) or the Code Division Multiple Access (CDMA2000). The legacy network 406 further comprises a conference controller 408, which is responsible for acting as a cluster super member for terminals of the network 406 that desire or accept to engage in multiparty conferencing with participants from the ad-hoc network 402.

Terminal A 400 is part of the ad-hoc network 402, which may be, for example a Wireless Local Area network (WLAN). In this exemplary scenario described in relation to FIG. 4, the terminal A 400 comprises a user agent for supporting cluster-based multi-party conferencing, the user agent being able to act either as a regular user agent as described in FIG. 2 or as a super user agent as described in FIG. 3. In the context of the described scenario, the user agent of the terminal A 400 acts as a super user agent (SUA) 410 capable of carrying on SIP-based multiparty conferences, including cluster-based ad-hoc conferences using clustering extensions. Similarly, the conference controller 408 comprises a modified SUA 412, which acts like a SUA 410, except for the fact that it is configured to be perceived by the ad-hoc network terminals as a special super member of a cluster that never leaves the conference or a cluster, and which is further perceived by terminals from the network 406 as a centralized control point for multiparty conferencing. Terminal B 404 comprises a basic user agent (BUA) 414, capable of handling SIP-based signalling, but without clustering extensions. The BUA 414 is not capable of acting as a super member of a cluster because it does not support the clustering extensions.

With reference to FIG. 4, when terminal A 400 intends to carry on a conference with terminals from the legacy network 406, the terminal may first need to register with the conference controller 408 to be able to carry on such conferences and, for this purpose, may send a SIP REGISTER message 401 to the conference controller 408 with the address 403 of terminal A and with an indication 405 that terminal A supports clustering extensions of SIP. The identity of the conference controller 408 may be known to the terminal A 400 in various manners, e.g. by an automatic redirection on a web page associated with the legacy network 406 followed by a selection of a conference controller for a given legacy network, by an advertisement message being broadcast to users of the ad-hoc network 402, or in any other suitable manner. Upon receipt of message 401, the conference controller 408 registers the address of terminal A as one of the addresses of terminals in the ad-hoc network with which terminals from the legacy network 406 can engage in conferencing and responds back with a SIP 202 message indicative of an acceptance of the registration. Terminal A 400 then registers the identity of the conference controller 408 as one of the controllers with which it is registered, action 411. Actions 401, 407, 409 and 411 are optional, as in some implementations they may not be needed.

When terminal A desires to invite terminal B 404 to participate to a conference, it may start by sending a SIP INVITE message 416 directly to terminal B 404, the message comprising a conference identifier 426 that identifies the new conference being set up, and clustering information 418. The terminal A 400 includes the clustering information 418 in the message 416 to show that its super user agent 410 supports clustering extensions and because, by default, the terminal A 400 is configured to initiates cluster-based conferences. The clustering information 418 comprises a cluster identifier 420 that uniquely identifies the new cluster of participants being created, cluster parameters 422 as described herein before, and a super member identifier 424 that identifies the super member of the cluster being created, which super member may be, in the present case, terminal A 400. Upon receipt of the message 416 with the clustering information 418, the terminal B 404 detects that its BUA 414 does not support the SIP clustering extensions contained therein and the information from these extensions (i.e. the clustering information), action 428, and notifies back the terminal A 400 with a SIP 420 message 430, which may optionally comprise a parameter 432 that explicitly states the reasons why the clustering extensions are not supported by the terminal B 404. (Parameter 432 may contain, for example, the identification of the network 406 as an indication that this network does not support SIP clustering extensions or the version of the SIP protocol being used). Based on the message 430, terminal A 400 may determine that the terminal B 404 does not support clustering and possibly that terminal B 404 is in a different network than the ad-hoc network 402 (in case the parameter 432 contains a network identification). Actions 416, 428, and 434 may also be optional, as in some implementations terminal A may be configured to skip them.

In action 436, terminal A 400 determines if it has a connection already established with the conference controller 408 of the network 406 where terminal B 404 resides. This may be the case when terminal A 400 is already engaged in a conference with another terminal (not shown) of the legacy network 406. In the affirmative, i.e. when terminal A 400 detects in action 436 that it already has an active connection 438 already established with the conference controller 408, terminal A 400 only needs to initiate the establishment of a second connection needed for the conference, between the conference controller 408 and terminal B 404, action 440, so that it can connect to its intended callee via the controller 408. Action 440 comprises a suite of sub-actions needed for the establishment of this second connection needed for the conference, which are shown in FIG. 4 within the dotted lines of action 440. Specifically, for this purpose, terminal A 400 sends a SIP REFER message 442 to the conference controller 408, the message 442 comprising an address 444 of the terminal B 404 so that the conference controller 408 knows which terminal to further contact, the clustering information 418 that specifies to the conference controller 408 that terminal A 400 supports clustering, and the conference identifier 426 that identifies the conference being set up. The conference controller 408 may authenticate the terminal A 400 in action 441, using for example the address 403 stored in action 407, or using any other suitable authentication technique, including contacting back the terminal A to have further authentication information from the user. Then, the conference controller 408 replies back to the terminal A 400 with a SIP 202 message that indicates acceptance of message 442, and further sends to the intended callee, i.e. to terminal B 404 a SIP INVITE message 448 that comprises the conference identifier 450. Terminal B 404 accepts the invitation to join a new session for the identified conference by sending back to the conference controller 408 a SIP 200 OK message 452, which receipt is acknowledged by the conference controller 408 via a SIP Ack message 454.

At the same time, in action 453, the conference controller 408 updates its SUA 412 with information relative to the cluster-based conference. Part of action 453, in the general case, the controller may update its SUA's cluster member list (which includes all identities of terminals of the legacy network that are members of the cluster of terminals participating to the conference) with any identity/address of a participant to the conference, may record in its SUA 408 the conference identity 426 that identifies the conference, may further update its SUA's cluster neighbour list (which stores identifies of terminals from the ad-hoc network that act as super members of a cluster in the ad-hoc network, and which also participate to the same conference), and may assign an identity to the cluster formed in the legacy network for supporting the requested conference. In the particular case described in the exemplary scenario of FIG. 4, the conference controller 408 acts in action 453 to update its SUA 412 with the identity 426 of the conference being created, to update its cluster member list with the address 444 of terminal B, and to further update its cluster neighbour list with the address 403 of terminal A.

The conference controller 408 then confirms the establishment of a new connection 460 intended for the conference with terminal B 404 by sending to terminal A 400 a SIP NOTIFY message 456 that comprises the conference identifier 426 and optionally the clustering information 418. The receipt of the message 456 by terminal A 400 is confirmed back to the conference controller 408 via a SIP 200 OK message 458. The second connection 460 of the conference is now set up between the conference controller 408 and terminal B 404 and, as a consequence, terminal A 400 can now communicate with terminal B 404 by exchanging messages via the connection 438 that extends between terminal A 400 and the conference controller 408, and further over the second connection of the conference, i.e. the connection 460 that extends between the conference controller 408 and the terminal B 404.

If in action 436 terminal A 400 rather determines that it does not have an active connection with the conference controller 408, such as when terminal A 400 has no ongoing communications with any terminal from the legacy network 406, the terminal A 400 selects the proper conference controller to be contacted, action 461. The controller's selection may be based on the registration of action 411, or simply on a default selection of a given conference controller which identity is stored in the terminal A 400. Then, terminal A 400 acts to create such a connection with the controller 408. Such a situation is illustrated following the negative response in action 436, when the method skips action 440 described previously and rather continues with the controller's selection of action 461 followed by the sending by terminal A 400 of a SIP INVITE message 462 to the conference controller 408 for establishing a connection with the later. The message 462 comprises the clustering information 418 (as described hereinbefore) and the conference identifier 426, thus informing the controller of the identity of the new conference being created and of the clustering capabilities of the terminal A 400. The conference controller 408 may act to authenticate terminal A 400 as described hereinbefore with reference to action 441, action 463, and in case of a successful authentication accepts the invitation by responding back with a SIP 200 OK message 464, which receipt by terminal A 400 is confirmed with a SIP Ack message 466. At this point, a connection 468 is established between the terminal A 400 and the conference controller 408.

Then, the method continues with action 440, as described hereinbefore, for establishing the second connection required for the conference between the terminal A 400 and the terminal B 404, the second connection extending from the conference controller 408 to terminal B 404. The same actions 442-458 are performed as described hereinbefore (except for the authentication of action 441, which has been already performed in action 463) in order to establish the connection 460. Subsequently, terminal A 400 can communicate with terminal B 404 by exchanging messages via the connection 438 between the terminal A 400 and the conference controller 408 and further over the second leg of the conference, i.e. over the connection 460 between the conference controller 408 and the terminal B 404.

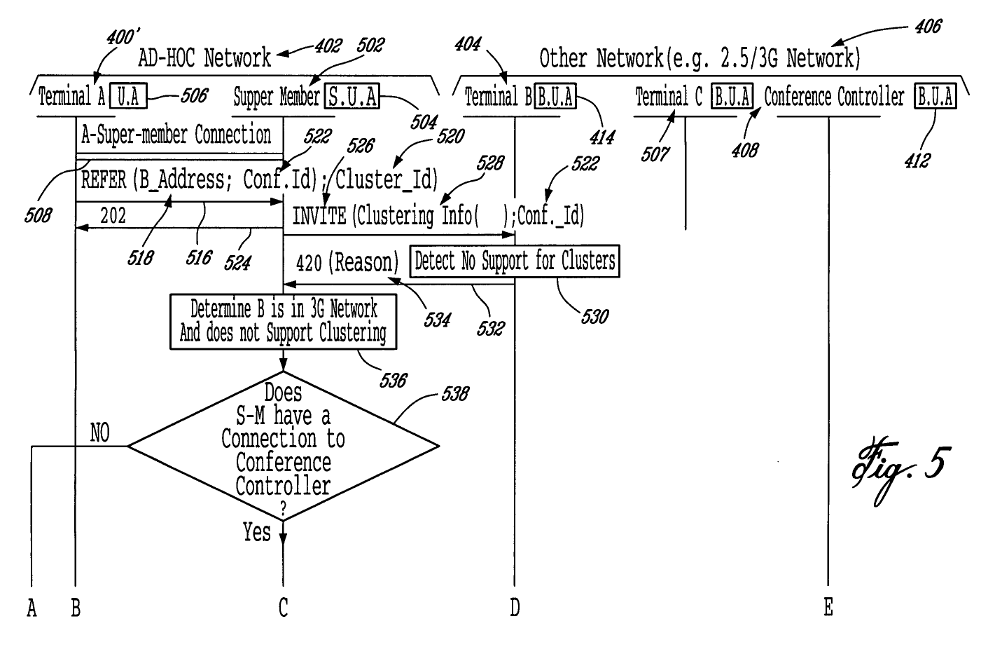

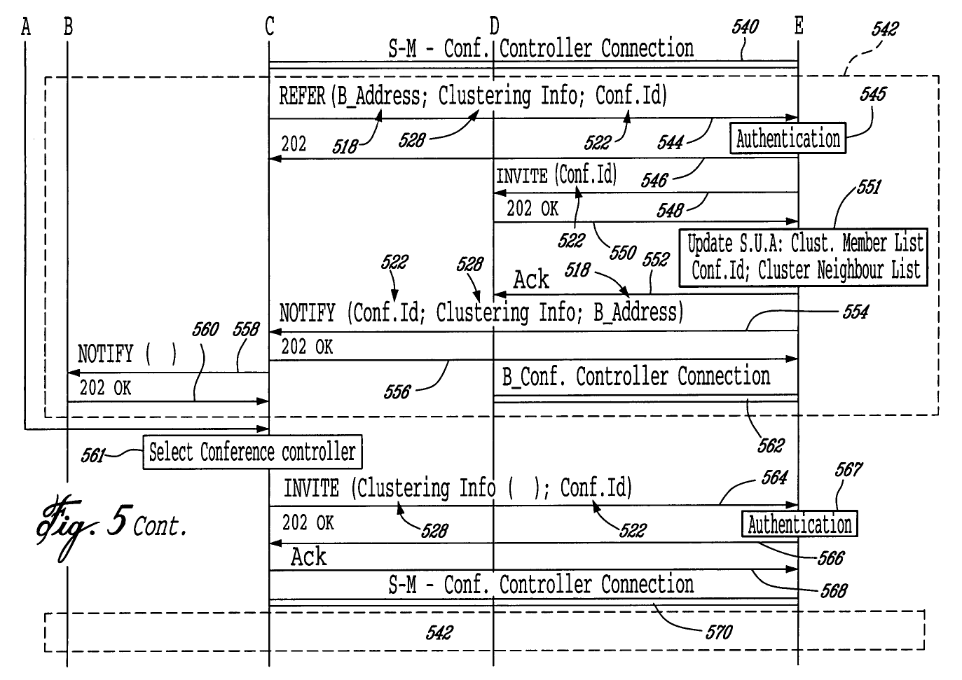

Reference is now made to FIG. 5, which is another exemplary high-level nodal operation and signal flow diagram representing a terminal of an ad-hoc network that establishes a connection with a terminal that does not support clustering, according to a second exemplary scenario of the preferred embodiment of the present invention, which is similar to the scenario described in FIG. 4, except for the fact that terminal A 400 does not act as a super member, but rather as a member of a cluster formed with another super-member. Therefore, FIG. 5 shows the same terminal B 404 with its BUA 414 and the same conference controller 408 with its modified SUA 412 as part of the legacy network 406, and a super member 502 comprising a SUA 504 carrying on an ad-hoc cluster-based conference over a connection 508 with terminal A 400′. In FIG. 5, terminal A 400′ comprises a UA 506, instead of a SUA like in FIG. 4, because it acts a regular cluster member and not like a super-member within a cluster formed with the super member 502 in the ad-hoc network 402. Terminal A 400′ and the super member 502 may be terminals of various types, part of the ad-hoc network 402, while terminal B 404 does not support cluster-based conferencing.

With reference to FIG. 5, the exemplary scenario described therein assumes that the super member 502 already performed a registration with the conference controller 408 in order to be able to connect thereto for carrying on conferencing with terminals from the legacy network 406, in an action similar to actions 401, 407, 409, and 411 described in relation to FIG. 4. However, in certain implementation, these actions may not be necessary since connecting to a conference controller of a given network may not require prior registration.

Terminal A 400′ is already engaged in a the conference with the super member 502, but may further desires to additionally invite terminal B 404 to participate to the conference. For this purpose, terminal A 400 sends a SIP REFER message 516 to its cluster's super member 502, the message comprising the address 518 of terminal B 404 (the callee), a conference identifier 522 that identifies the conference that is already ongoing between terminal A 400′ and its super member 502, and an identifier 520 of the cluster established between terminal A 400′ and its super member 502. Receipt of the message 516 by super member 502 is confirmed back to terminal A 400′ via a SIP 202 message 524. The super member 502 then attempts to create a connection with terminal B 404 so that it can join the conference and, for this purpose may send a SIP INVITE message 526 to terminal B 404, the message comprising the conference identifier 522 that identifies the conference, and clustering information 528.

Upon receipt of the message 526 with the clustering information 528, the terminal B 404 detects that its BUA 414 does not support clustering, action 530, and notifies back the super member 502 with a SIP 420 message 532, which may optionally comprise a parameter 534 that explicitly states that the reasons why clustering is not supported by the terminal B 404, as previously described in relation to action 430. Based on the message 532, the super member 502 may determines that terminal B 404 does not support clustering, or also that it is in a different network than the ad-hoc network 402. Then, in action 538, the super member 502 determines if it has a connection already established with the conference controller 408 of the network 406 where terminal B 404 resides. The identification of the controller 408 may be based on the prior registration of the super member 502 with the controller 408, as described hereinbefore, or on the identity of the controller 408 being received in action 532.

In the affirmative, i.e. when the super member 502 detects in action 436 that it already has an active connection 540 already established with the conference controller 408 (this may happen in circumstances when another terminal C 507 from the legacy network also takes part to the same conference with terminal A 400′ and the super member 502, and the super member 502 has already established a connection to the conference controller to be able to communicate with terminal C 507), the super member 408 only needs to initiate the establishment of a second connection needed for terminal B participation to the conference, action 542, i.e. the establishment of a connection between the conference controller 408 and terminal B 404, so that terminal A 400′ can connect to its intended callee, via controller 408. Action 542 comprises a suite of sub-actions needed for the establishment of this second connection, which are shown in FIG. 5 within the dotted lines of action 542. Specifically, for this purpose, the super member 502 sends a SIP REFER message 544 to the conference controller 408, the message 544 comprising the address 518 of the terminal B 404 so that the conference controller 408 knows which terminal to further contact, the clustering information 528 that specifies to the conference controller 408 that the super member 502 supports clustering, and the conference identifier 522 that identifies the conference to which the terminal B 404 is invited. The conference controller 408 may act in action 545 to authenticate the super member 502 using, for example, the information received during the prior registration, or may request as part of action 545 further authentication information from the super member 502. Upon successful authentication of the super member 502, the conference controller 408 replies back to the super member 502 with a SIP 202 message 546 that confirms the receipt of message 544, and further sends to the intended callee, i.e. to terminal B 404 a SIP INVITE message 548 that comprises the conference identifier 522. Terminal B 404 accepts the invitation to join the conference by sending back to the conference controller 408 a SIP 200 OK message 550, which receipt is acknowledged by the conference controller 408 via a SIP Ack message 552.

At the same time, in action 551, the conference controller 408 updates its SUA 412 with information relative to the cluster-based conference. Part of action 551, in the general case, the controller may update its SUA's cluster member list (which includes all identities of terminals of the legacy network that are members of the cluster of terminals participating to the conference) with any identity/address of a participant to the conference, may record in its SUA 408 the conference identity 426 that identifies the conference, may further update its SUA's cluster neighbour list (which stores identifies of terminals from the ad-hoc network that act as super members of a cluster in the ad-hoc network, and which also participate to the same conference), and may assign an identity to the cluster formed in the legacy network for supporting the requested conference. In the particular case described in the exemplary scenario of FIG. 5, the conference controller 408 acts in action 551 to update its SUA 412 with the identity 522 of the conference being created, to update its cluster member list with the address 518 of terminal B, and to further update its cluster neighbour list with the address of the super member 502.

The conference controller 408 then confirms the establishment of a new connection intended for the conference of terminal B 404 by sending to super member 502 a SIP NOTIFY message 554 that comprises the address 518 of terminal B, the conference identifier 522 and optionally the clustering information 528 for identifying the cluster for which the connection is to be set up. The receipt of the message 554 by super member 502 is confirmed back to the conference controller 408 via a SIP 200 OK message 556, and the super member 502 further notifies terminal A 400′ that the requested connection for the conference with terminal B 404 is set up, using a SIP NOTIFY message 558 that comprises the same information as the message 554. Successful receipt of the message 558 by terminal A 400′ is confirmed back to the super member using a SIP 200OK message 560.

The second connection 562 of the conference is now set up between the conference controller 408 and terminal B 404, and as a consequence, terminal A 400′ can now communicate with terminal B 404 by exchanging messages via connection 508 that extends between itself and its super member 400′, via connection 540 that extends between super member 502 and the conference controller 408, and further over the connection 562 that extends between the conference controller 408 and terminal B 404.

If in action 538, super member 502 rather determines that it does not have an active connection with the conference controller 408, super member 502 first acts to select the proper conference controller to contact for the establishment of a connection with terminal B 404. In such a situation, illustrated following the negative response in action 538, the method skips action 542 shown in dotted lines, and rather continues with the selection of the conference controller, action 561, which may be based on the prior registration with the controller, or simply on a default selection of a given conference controller which identity is stored in the terminal A 400′. The, the super member 502 sends a SIP INVITE message 564 to the selected conference controller 408 for establishing a connection with the later. The message 564 comprises the clustering information 528 and the conference identifier 522, thus informing the controller of the identity of the conference being created and of the clustering capabilities of super member 502. The conference controller 408 may act to authenticate the super member 502 as described hereinbefore, action 567, and in the case of a successful authentication accepts the invitation by responding back with a SIP 200 OK message 566, which receipt by super member 502 is confirmed with a SIP Ack message 568.

At this point, a connection 570 is established between the super member 502 and the conference controller 408.

Then, the method continues with action 542, as described herein before, for establishing the last connection needed for the conference between terminal A 400 and the terminal B 404, this last connection extending from the conference controller 408 to terminal B 404. The same actions 544-560 are performed as described hereinbefore in order to establish the connection 562, except for the authentication of the super member 502, which may be skipped since it was already performed in action 567. Subsequently, terminal A 400′ can communicate with terminal B 404 by exchanging messages via connection 508 that extends between itself and its super member 502, via connection 570 that extends between super member 502 and the conference controller 408, and further over the connection 562 that extends between the conference controller 408 and terminal B 404.

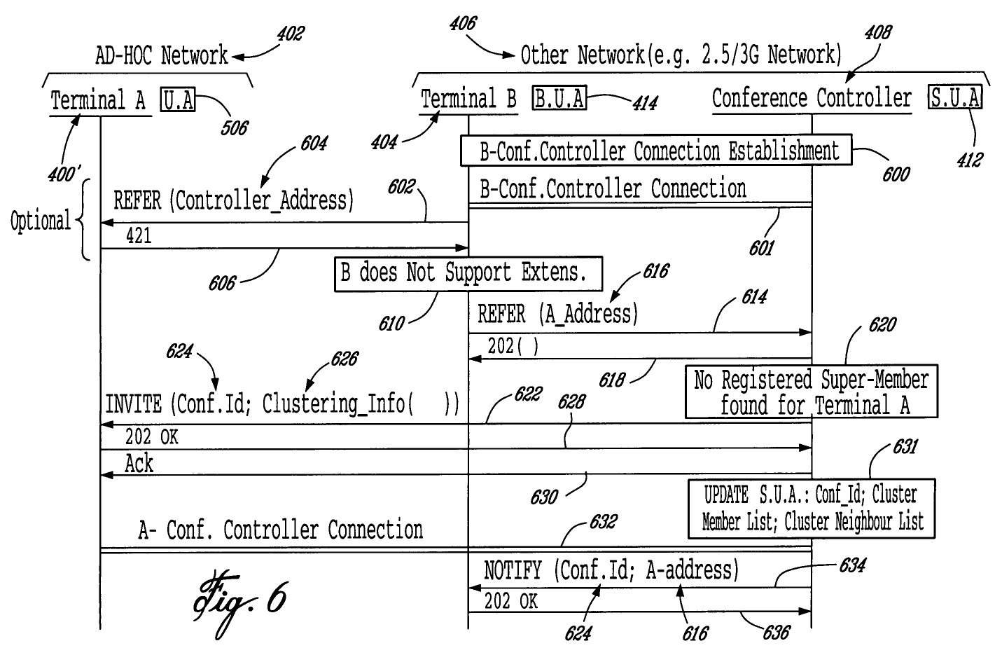

Reference is now made to FIG. 6, which is yet another exemplary high-level nodal operation and signal flow diagram representing a terminal B 404 that does not support clustering, which establishes a connection with a terminal A 400′ of an ad-hoc network according to a third exemplary scenario of the preferred embodiment of the present invention. Shown in FIG. 6 is terminal A 400′ with its UA 506, a terminal B 404 with its BUA 414, and the conference controller 408 with its modified SUA 412. In FIG. 6, terminal A 400′ may be a terminal of various types, part of the ad-hoc network 402, while terminal B 404 is part of, for example, a legacy network 406, and does not support cluster-based conferencing. The UA 506 of terminal A 400′ may change status and become a SUA by changing the super member status to ON (as shown in FIGS. 2 and 3) when the terminal A 400′ becomes super member of a given cluster.

When terminal B 404 desires to establish a conference with terminal A 400′, it may be so configured as to first start, in action 600, to establish a connection 601 with its conference controller 408.

Thereafter, once the connection 601 is established between the terminal B 404 and the conference controller 408, in a possible implementation of the invention, terminal B 404 may attempt to invite directly terminal A 400″ to join a conference and for this purpose, to establish a connection with its conference controller 408, by sending a SIP REFER message 602 comprising the address 604 of the conference controller 412. Because the terminal A 400′ is configured by default to support clustering, it sends back to terminal B 404 a SIP 421 message that indicates that the message 602 lacks the clustering information terminal A 400′ expected to receive.

Upon receipt of message 606, terminal B 404 determines that it does not support clustering, action 610. Same action 610 may be performed by terminal B 404 directly after the establishment of the connection 601 with the conference controller 408 and without actions 602 and 606. Terminal B 404 requests the conference controller 408 to establish a connection with terminal A 400′ on its behalf, by sending to the controller 408 a SIP REFER message 614 with the address 616 of terminal A 400′. Receipt of message 614 by the controller 408 is confirmed back to the terminal B 404 via a SIP 202 message 618. Further in action 620, the controller 408 determines that there is no registered super member associated with terminal A 400′, which means that terminal A is presently not engaged in a cluster-based conference with others. Action 620 may be performed by determining if the conference controller 408 has received any prior registration from a super member of the ad-hoc network 402 associated with terminal A. In the negative, i.e. if in action 620 it is determined that there is no super member associated with terminal A 400′, the conference controller 408 sends a SIP INVITE message 622 to terminal A 400′ to invite it to a conference with terminal B 404. Message 622 comprises a conference identifier 624 for identifying the conference being set up between terminals A and B, and clustering information 626 that comprises a cluster identifier for identifying a cluster being created between the conference controller 408 that acts as a super member, cluster parameters, and the super member identifier, i.e. the address of the conference controller 408. Terminal A 400′ accepts the connection with a SIP 200 OK message 628 sent back to the controller 408, which confirms the receipt of message 628 with a SIP Ack message 630.

At the same time, in action 631, the conference controller 408 updates its SUA 412 with information relative to the cluster-based conference. Part of action 631, in the general case, the controller may update its SUA's cluster member list (which includes all identities of terminals of the legacy network that are members of the cluster of terminals participating to the conference) with any identity/address of a participant to the conference, may record in its SUA 408 the conference identity 624 that identifies the conference, may further update its SUA's cluster neighbour list (which stores identifies of terminals from the ad-hoc network that act as super members of a cluster in the ad-hoc network, and which also participate to the same conference), and may assign an identity to the cluster formed in the legacy network for supporting the requested conference. In the particular case described in the exemplary scenario of FIG. 6, the conference controller 408 acts in action 631 to update its SUA 412 with the identity 624 of the conference being created, to update its cluster member list with the address of terminal B (only in case the address of terminal B needs to be recorded or confirmed again, since it was registered as part of action 600 when the connection 601 was created), and to further update its cluster neighbour list with the address 616 of terminal A.

A connection 632 is established between the terminal A 400′ and the conference controller 408. This is signalled from the conference controller 408 to the terminal B 404 via a SIP NOTIFY message 634 that may comprise the address 616 of terminal A and the conference identifier 624 that identifies the conference between terminals A and B. The terminal B responds back to the conference controller with a 200 OK message 636 for confirming it has accepted to join the conference.

Subsequently, terminal A 400′ can communicate with terminal B 404 by exchanging messages via connection 601 that extends between itself and the conference controller 408 and via connection 632 that extends between the conference controller 408 and terminal A 400′.

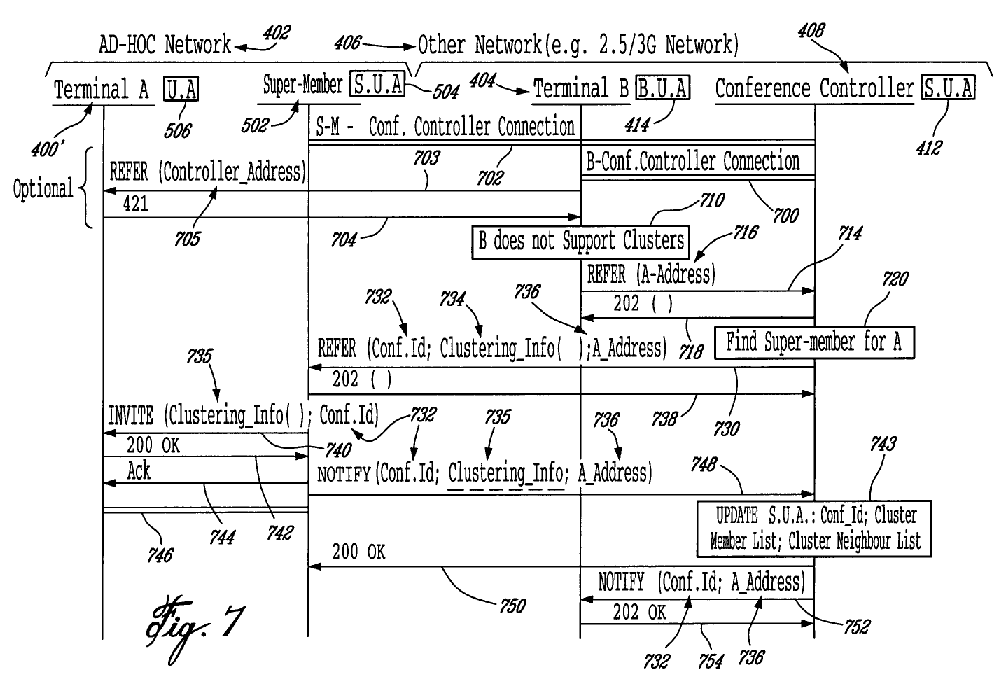

Reference is now made to FIG. 7, which is yet another exemplary high-level nodal operation and signal flow diagram representing a terminal B 404 that does not support clustering, which establishes a connection with a terminal A 400′ of an ad-hoc network according to a forth exemplary scenario of the preferred embodiment of the present invention. Shown in FIG. 7 are, in the ad-hoc network 402, terminal A 400′ with its UA 506, a super member 502 with its SUA 504, and in a legacy network 406, a terminal B 404 with its BUA 414, and the conference controller 408 with its modified SUA 412. In FIG. 7, terminal A 400′ may be a terminal of various types, part of the ad-hoc network 402, while terminal B 404 equipped with a BUA does not support cluster-based conferencing. It is also assumed in FIG. 7 that terminal B 404 is already carrying on a multi-party conference with the super member 502 and the super member 502 from the ad-hoc network 402, over a connection 700 that extends between itself and its conference controller 408 and further over a connection that extends between the conference controller 408 and the super member 502. The conference controller 408 acts as a super member for the cluster formed by the controller itself and the terminal B 404 which acts as a regular cluster member, while the super member 502 is the only member of a cluster on the side of the ad-hoc network 402.

When terminal B 404 desires to further invite terminal A 400′ to the same conference, in a possible implementation of the invention, terminal B 404 may attempt to directly invite terminal A 400′ to establish a connection with its controller 408, by sending a SIP REFER message 703 comprising the address 705 of the conference controller 408. Because the terminal A 400′ is configured by default to support clustering, it sends back to terminal B 404 a SIP 421 message 704 that indicates that the message 703 lacks the clustering extensions terminal A 400′ expected to receive.

Upon receipt of message 704, terminal B 404 determines that it does not support clustering, action 710. In another possible implementation of the invention, the same action 710 may be performed by terminal B 404 without actions 703 and 704. Terminal B 404 requests the conference controller 408 to establish a connection with terminal A 400′ on its behalf, by sending to the controller 408 a SIP REFER message 714 with the address 716 of terminal A 400′. Receipt of message 714 by the controller is confirmed back to the terminal B 404 via a SIP 202 message 718. Further in action 720, the controller 408 determines whether or not there exists a super member with which the terminal A can be associated in order to carry on the conference in the ad-hoc network 402. Action 720 may comprise determining if in the network of origin of the terminal A 400′ there is any super member 402 that participates to the conference. In the present exemplary scenario, in action 720, the super member 502 is identified as carrying on the conference and being part of the ad-hoc network 402. As a consequence, the super member 402 appears as a good candidate to the conference controller to act as a super member also for terminal A 400′, i.e. to form a cluster with the later.

Following action 720, the conference controller 408 sends a SIP REFER message 730 to the super member 502, the message 730 comprising a conference identifier 732 for identifying the conference already set up between the super member 502 and the terminal B 404 (via the controller 408), clustering information 734 that comprises a cluster identifier for identifying the status of super member of the conference controller 408, as well as the address 736 of terminal A 400′ which specifies to the super member 502 that it is terminal A 400′ which is being invited to joint the conference. Receipt of message 730 by the super member 502 is confirmed back to the conference controller 408 via a SIP 202 message 738.

The super member 502 then sends a SIP INVITE message 740 to terminal A 400′ to invite it to join the conference. Message 740 comprises the conference identifier 732 for identifying the conference terminal A is invited to join and clustering information 735 that comprises a cluster identifier for identifying the status of super member of the super member 502 in its own cluster.

Terminal A 400′ accepts to join the conference with a SIP 200 OK message 742 sent back to the super member 502, which confirms the receipt of message 742 with a SIP Ack message 744. The connection 746 is established between the terminal A 400′ and the super member 502 in order to support the conference. This is signalled back from the super member 502 to the conference controller 408 via a SIP NOTIFY message 748 that may comprise the address 736 of terminal A 400′, the conference identifier 732 that identifies the conference, and optionally clustering information 735 including the cluster's members which identifies terminal A 400′ as one of the cluster's members. The address 736 can be sent in message 748 also as part of the clustering information 735.

In action 749 the conference controller 408 updates its SUA with the information received in message 748, i.e. registers that terminal A 400′ has joined the conference via its super member 502. Then, the conference controller 408 answers back to the super member 502 with a SIP 200 OK message 750 to confirm receipt of message 748.

In action 749, the conference controller 408 updates its SUA 412 with information relative to the cluster-based conference. Part of action 749, in the general case, the controller may update its SUA's cluster member list (which includes all identities of terminals of the legacy network that are members of the cluster of terminals participating to the conference) with any identity/address of a participant to the conference, may record in its SUA 408 the conference identity 732 that identifies the conference, may further update its SUA's cluster neighbour list (which stores identifies of terminals from the ad-hoc network that act as super members of a cluster in the ad-hoc network, and which also participate to the same conference), and may assign an identity to the cluster formed in the legacy network for supporting the requested conference. In the particular case described in the exemplary scenario of FIG. 7, the conference controller 408 acts in action 749 to update its SUA 412 with the identity 732 of the conference being created, to update its cluster member list with the address of terminal B (only in case the address of terminal B needs to be recorded or confirmed again, since it was registered as part of the action of creating the connection 700), and to further update its cluster neighbour list with the address of the super member 502.

The connection 746 is established between the terminal A 400′ and the super member 502, which is further notified to terminal B 404 via a SIP NOTIFY message 752, comprising the conference identifier 732 and the address 736 of terminal A 400′. Terminal B 404 responds back to the conference controller 408 with a 200 OK message 754 for confirming it has been informed that terminal A 400′ has accepted to join the conference.

Subsequently, terminal A 400′ can communicate with terminal B 404, and vice versa, by exchanging messages during the conference which is carried on over connection 746 that extends between terminal B 404 and the super member 502, over connection 702 that extends between the super member 502 and the conference controller 408, and over the connection 700 that extends between the conference controller 408 and the terminal B 404.

The exemplary scenario described with reference to FIG. 7 may be a possible continuation of the one described in FIG. 6, where a multi-party conference is established between the terminal B 404 of the legacy network 406 and the terminal A 400′ of the ad-hoc network 402, via the conference controller 408. In this scenario, the conference controller 408 acts as a super member for terminal B 404, together forming a cluster in the legacy network, while terminal A 400′ form a cluster by itself in the ad-hoc network where it acts as a super member with no other members. The scenario of FIG. 7 continues with the same conference controller 408 and terminal B 404, engaged in the conference with the terminal A of FIG. 6, but which becomes the super member of FIG. 7. The scenario thus continues with the invitation of another terminal, denoted terminal A in FIG. 7, to join the conference.

Therefore, with the present invention it becomes possible to carry on flexible and scalable multi-party conferences between parties of ad-hoc networks and parties in a legacy network, which do not support cluster-based conferencing.

It is to be noted that the signaling exchange described in relation with FIGS. 4, 5, 6, and 7 may be actually performed by the user agents and super user agents which are resident in the shown terminals and nodes. Thus, upon reading of the description associated with these Figures, one should understand that it is the user agents and super user agents described for each such terminal and nodes, which are responsible for receiving, processing, and sending the described messages.

Based upon the foregoing, it should now be apparent to those of ordinary skills in the art that the present invention provides an advantageous solution, which offers the possibility of establishing multi-party conferences between parties in an ad-hoc network and parties in a legacy network. Although the system and method of the present invention have been described in particular reference to certain radio telecommunications messaging standards like SIP, it should be realized upon reference hereto that the innovative teachings contained herein are not necessarily limited thereto and may be implemented advantageously with other applicable radio telecommunications standards and protocols. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for multi-party conferencing between terminals of an ad-hoc network and terminals of a legacy network, the method comprising the steps of:
a. receiving at a conference controller of the legacy network a first message for an establishment of a conference between a terminal in the ad-hoc network and a terminal in the legacy network;
b. responsive to a receipt of the first message, sending from the conference controller a second message to establish a first connection between the conference controller and one of the terminal in the legacy network and the terminal in the ad-hoc network;
c. updating a Super User Agent (SUA) of the conference controller with information relative to the conference, the SUA being for use in establishing cluster-based conferences, and comprising:
a conference identity that identifies the conference;
a cluster member list including identities of terminals of the legacy network that are members of a cluster of terminals of the legacy network which participate to the conference; and
a cluster neighbour list that identifies at least one terminal from the ad-hoc network that acts as a super member of a cluster of at least one terminal of the ad-hoc network, the at least one terminal from the ad-hoc network also participating to the same conference; and
d. notifying at least one of the terminal in the ad-hoc network and the terminal in the legacy network that the first connection for use by the conference is established.

2. The method claimed in claim 1, further comprising the step of:
e. receiving at the conference controller a third message related to the establishment of a second connection for use by the conference, the second connection being between the conference controller and the other one of the terminal in the ad-hoc network and the terminal in the legacy network.

3. The method claimed in claim 1, wherein the first message is a Session Initiation Protocol (SIP) REFER message sent from the terminal in the ad-hoc network and the second message is a SIP INVITE message sent to the terminal in the legacy network.

4. The method claimed in claim 1, wherein the first message is a Session Initiation Protocol (SIP) INVITE message sent from the terminal in the ad-hoc network and the second message is a SIP INVITE message sent to the terminal in the legacy network.

5. The method claimed in claim 1, wherein the first message is a Session Initiation Protocol (SIP) REFER message sent from the terminal in the legacy network and the second message is a SIP INVITE message sent to the terminal in the ad-hoc network.

6. The method claimed in claim 1, wherein the first message is a Session Initiation Protocol (SIP) REFER message sent from the terminal in the legacy network and the second message is a SIP REFER message sent to the terminal in the ad-hoc network.

7. The method claimed in claim 1, wherein the first message comprises clustering information associated with a cluster of terminals to which a sender of the first message belongs.

8. The method claimed in claim 1, wherein the second message comprises clustering information associated with the cluster of terminals of the legacy network.

9. The method claimed in claim 1, wherein step d. comprises sending a Session Initiation Protocol (SIP) NOTIFY message from the conference controller to notify one of the terminal in the ad-hoc network and the terminal in the legacy network that the first connection for use by the conference is established.

10. A conference controller of a legacy network, comprising:
a super user agent for use in establishing cluster-based conferences, the super user agent comprising:
a conference identity that identifies a given conference;
a cluster member list including identities of any terminals of the legacy network that are members of a cluster of terminals of the legacy network which participate to the given conference; and
a cluster neighbour list that identifies at least one terminal from an ad-hoc network that acts as a super member of a cluster of at least one terminal of the ad-hoc network, the at least one terminal from the ad-hoc network also participating to the given conference;
the super user agent, responsive to a receipt of a first message for an establishment of the given conference between a terminal in the ad-hoc network and a terminal in the legacy network, sending a second message to establish a first connection between the conference controller and one of the terminal in the legacy network and the terminal in the ad-hoc network, storing information relative to the given conference, and notifying at least one of the terminal in the ad-hoc network and the terminal in the legacy network that the first connection for use by the given conference is established.

11. The conference controller claimed in claim 10, wherein the super user agent of the conference controller receives a third message related to the establishment of a second connection for use by the conference, the second connection being between the conference controller and the other one of the terminal in the ad-hoc network and the terminal in the legacy network.

12. The conference controller claimed in claim 10, wherein the first message is a Session Initiation Protocol (SIP) REFER message sent from the terminal in the ad-hoc network and the second message is a SIP INVITE message sent to the terminal in the legacy network.

13. The conference controller claimed in claim 10, wherein the first message is a Session Initiation Protocol (SIP) INVITE message sent from the terminal in the ad-hoc network and the second message is a SIP INVITE message sent to the terminal in the legacy network.

14. The conference controller claimed in claim 10, wherein the first message is a Session Initiation Protocol (SIP) REFER message sent from the terminal in the legacy network and the second message is a SIP INVITE message sent to the terminal in the ad-hoc network.

15. The conference controller claimed in claim 10, wherein the first message is a Session Initiation Protocol (SIP) REFER message sent from the terminal in the legacy network and the second message is a SIP REFER message sent to the terminal in the ad-hoc network.

16. The conference controller claimed in claim 10, wherein the first message comprises clustering information associated with a cluster of terminals to which a sender of the first message belongs.

17. The conference controller claimed in claim 10, wherein the second message comprises clustering information associated with the cluster of terminals of the legacy network.

18. The conference controller claimed in claim 10, wherein step d. comprises sending a Session Initiation Protocol (SIP) NOTIFY message from the conference controller to notify one of the terminal in the ad-hoc network and the terminal in the legacy network that the first connection for use by the conference is established.

19. The conference controller claimed in claim 10, wherein the information relative to the given conference includes the conference identity and the cluster neighbour list.
